(19) United States
(12) Patent Application Publication
(10) Pub. No.: US 2017/0247207 A1
(43) Pub. Date: Aug. 31, 2017

(54) INFLATABLE SEAL FOR DOOR OPENINGS

(71) Applicant: Reuterwall Holding AB, Orebro (SE)

(72) Inventor: Vidar Reuterwall, Orebro (SE)

(73) Assignee: Reuterwall Holding AB, Orebro (SE)

(21) Appl. No.: 15/428,206

(22) Filed: Feb. 9, 2017

(30) Foreign Application Priority Data
Feb. 22, 2016 (EP) 16 15 6701

(51) Int. Cl. B65G 69/00; E06B 7/23

(52) U.S. Cl. CPC B65G 69/008; E06B 7/2318

(57) ABSTRACT

An inflatable door seal for sealing a vehicle includes inflatable members at its right and left sides, wherein each of the inflatable members includes at least one vertical inflatable portion for sealing against sides of the vehicle, a curtain portion for sealing against the roof of the vehicle, and a bottom seal portion for sealing between the floor ground and the vehicle. A method of inflating an inflatable door seal is also provided.

### BACKGROUND AND SUMMARY

The present invention relates to a method for inflating a seal device for door openings in a wall, more particularly the invention is concerned with an inflatable seal for door openings in a service building for vehicles or trains.

Inflatable seal devices for door openings are known from, for example, U.S. Pat. No. 4,821,468. Known inflatable seals generally comprise a hollow, flexible, inflatable, horizontal top section and a pair of hollow inflatable vertical side sections arranged at a loading door opening. These sections may constitute three separate members independently mounted at the opening with their interiors in air flow communication as described in U.S. Pat. No. 3,714,745 or they may constitute a single generally U-shaped member as shown in U.S. Pat. No. 3,303,615.

The seal devices serve to seal the loading area of a service building in which the personnel operate from the external environment so that the personnel are sheltered during poor weather. In addition the seal devices serve to prevent loss of heat from a heated building to a cold environment during winter, or prevent access of hot humid air to a cooled or air-conditioned building during summer.

Seal devices of the general type comprising separate members, such as shown in U.S. Pat. No. 3,714,745, have the advantage that the members can be spaced apart, at the time of installation, at the door opening, so that they do not interfere or intrude into the entry passage in front of the door opening, and additionally they can be more readily adapted to different door size openings.

With known solutions of inflatable seals it is not possible to seal a train or train set with an overhead line, also known as catenary, since a horizontal section will interfere with the overhead line.

It is desirable to provide a door or dock seal device overcoming the afore mentioned disadvantages

Thus, according to an aspect of the present invention, a method of inflating an inflatable door seal for positioning in an door opening of a wall and for sealing a vehicle, wherein the door seal comprises inflatable members at its right and a left sides, wherein each of the inflatable members comprises a vertical inflatable portion and an isolating part arranged at its uppermost end; a curtain portion and a bottom seal portion, wherein the inflatable members are inflated so that the vertical inflatable portion and the bottom seal portions are expanding, preferably substantially horizontally, towards the side of the vehicle and such that the isolating parts of the inflatable members meet at the vehicle roof, wherein said inflatable members are inflated to such extent that the curtain portions are expanding downwards, preferably substantially vertically, towards the roof of the vehicle.

The present invention also relates according to an aspect thereof to an inflatable door seal for positioning in a door opening of a wall and for sealing a vehicle, wherein the door seal comprises inflatable members at its right and left sides, wherein each of said inflatable members comprise at least one vertical inflatable portion for sealing against the sides of the vehicle, a curtain portion for sealing against the roof of the vehicle and a bottom seal portion for sealing between the ground and the vehicle.

According to one embodiment, the isolating part comprises one upper recess for preventing contact between the inflatable members and the overhead line and one lower recess for preventing contact between the inflatable members and the electrical contact arm of the vehicle when the inflatable seal is inflated.

According to one embodiment, the isolating part is box-shaped.

According to one embodiment, the two recesses are semi-circle shaped.

According to one embodiment, the at least one vertical inflatable portion is arranged with counterweights to facilitate opening of the seal in inflated and closed state.

According to one embodiment, the bottom seal portion comprises at least five parallel elongated tube-shaped air-communicating inflatable sections extending from the right side of the main vertical portion, preferably obliquely, downwards to the bottom of the door seal.

According to one embodiment, the tube-shaped inflatable section has a width in the range of 1-30 cm and a length in the range of 50-200 cm.

By the an aspect of the invention, a seal device for sealing and securing the overhead line of a vehicle e.g. a tramcar, a trace bus, a train or a train set, without interference between the overhead line of the vehicle and the seal device, is provided.

The seal device for sealing and securing the overhead line of the vehicle, such as a train or a train set may go from deflated to inflated state or from inflated state to deflated state within a cycle time of less than one minute.

### BRIEF DESCRIPTION OF THE DRAWINGS

Further advantages and effects will emerge upon study and consideration of the following, detailed description of the invention with simultaneous reference to the appended drawing figures, in which:

FIG. 1 is a schematic front view of the inflated seal door mounted at a door opening in a wall.

FIG. 2 is a schematic front view of the inflatable portions of the right side of an inflated seal door mounted at a door opening in a wall.

FIG. 3 is a schematic front view of the right side of an inflatable seal door device according to FIG. 2. FIG. 3 shows air ducts and details of the retraction system for the main vertical and top portions.

FIG. 4 is a schematic view of the right side of an inflatable seal door device according to FIG. 2, showing air ducts and details of the retraction system for the curtain portion.

### DETAILED DESCRIPTION

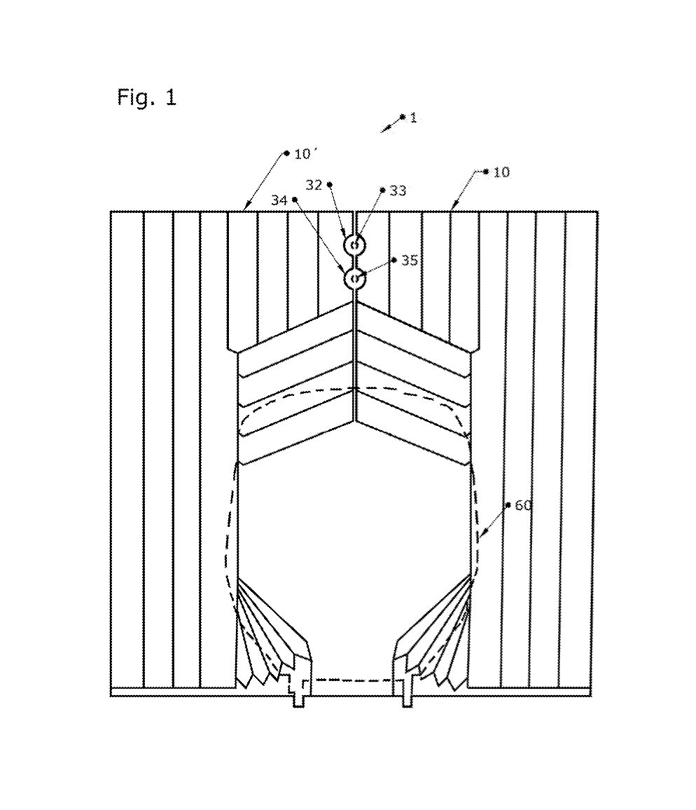

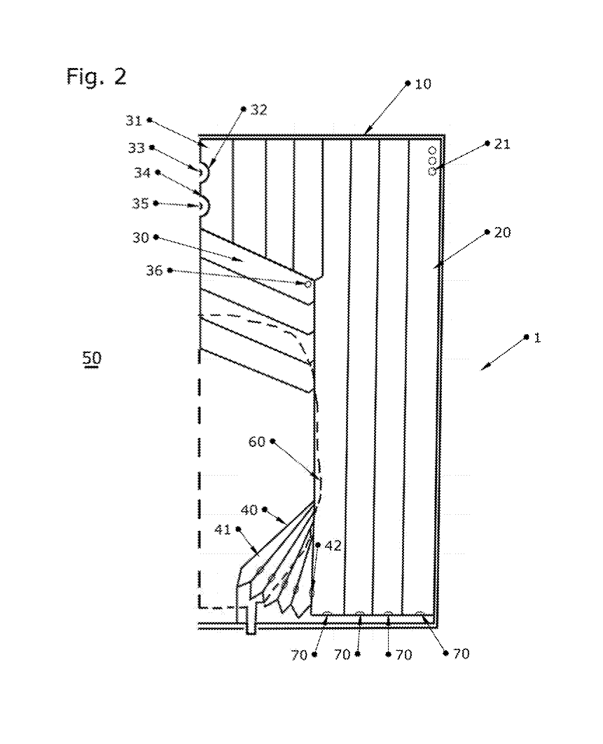

Seal device 1 in FIG. 1 comprises a pair of generally vertical inflatable side members 10, 10′, a right side member 10 and a left side 10′ member. It can be seen from FIG. 2 that the right side member 10 is in opposed facing relationship adjacent the right side edge and the top edge of the door opening 50. In the same manner, left side member 10′, FIG. 1, which is identical but reversed to the right side member 10, is opposed facing relationship adjacent the left side edge and the top edge of the door opening 50.

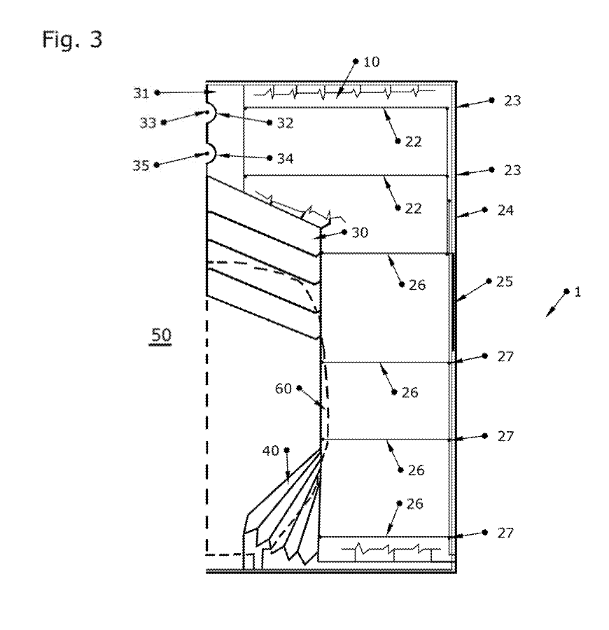

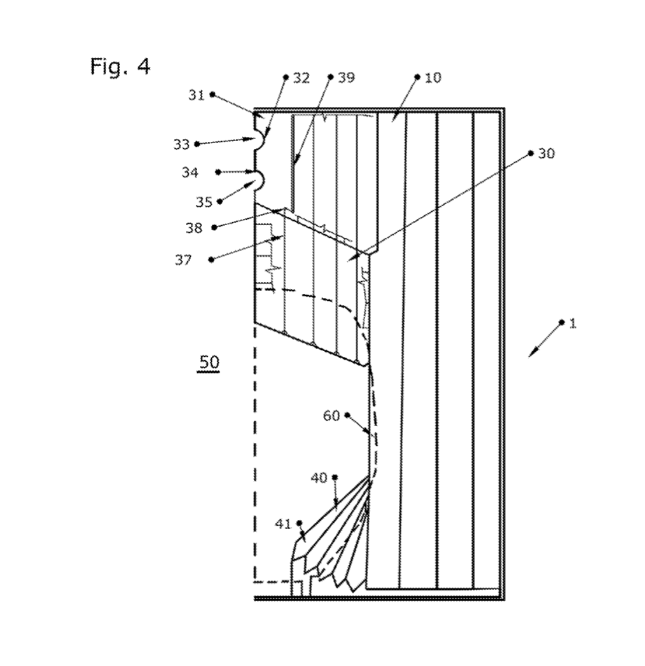

Each of these two side members 10, 10′, comprise a vertical main portion 20, a horizontal top portion 30, also named curtain portion, and an inclined bottom seal portion 40, also named foot portion. The seal device 1, FIGS. 3 and 4, further comprise a retraction system, comprising two set-ups of retraction parts, one for each side member 10, 10′. The retraction system may provide a constant retraction force on the side members 10, 10′.

The side members 10, 10′ have their major axis of inflation extending laterally to the side members 10, 10′. The phantom axis of inflation is perpendicular to a phantom axis of the door opening 50.

The inflatable portions 20, 30 and 40 may be formed of flexible fabric or material are impervious to air, tear-resistant and capable of repeated engagement with vehicles without damage. Suitable materials include vinyl coated nylon, for example, neoprene coated nylon.

In operation, an air fan may provide a constant flow of air under pressure maintaining the inflatable portions 20, 30, 40 inflated but yieldable. According to one embodiment, the inflatable system is not airtight, since air escapes continuously from a vent, so that the inflatable portions 20, 30, 40 are yieldable and are readily deformed in response to movement of a vehicle 60, for example a train 60, to form a pliant, cushioning seal around the train 60.

Preferably, when the inflated portions 20, 30, 40 are to be collapsed, a first air fan is switched off and the air escapes through ducts and vent under the elastic retracting force of retractors, counterweight force of retractors and of torsion spring.

Preferably, the vertical main portions 20 of the side members 10 inflate laterally of the door opening 50 directly towards each other and thus in a direction generally perpendicular to phantom axis of the entry of the door opening 50.

Thus the seal device 1 of the invention can readily be adapted to door openings 50 of various widths.

According to one embodiment, the bottom seal portion 40 which bridges the space between the vertical members 10, 10′ and the underside of the train 60 provides an inflated bottom seal improving the overall efficiency of the seal device 1.

In conventional sealing devices there is no inflated bottom seal, and the space is either open permitting entry or exit of warm air, or hanging flaps of sheet material are employed to bridge the gap under the train. In practice, the personnel tend to ignore the use of the flaps even when provided, in view of the inconvenience of the necessary installation, so that undesired heat loss or heat entry occurs, thereby reducing the efficiency of the system.

The following description, FIGS. 2-4, of the inflatable seal device 1 concerns inflatable portions and retraction parts for the right side member 10 only, as the right side and left side members are identical but reversed. The top portion 30, also named curtain portion, comprises an insulating part 31, preferably box-shaped, adapted for preventing direct contact between the overhead line 33 of the train 60 and the inflatable portions 20, 30, 40 of the right side member 10.

According to one embodiment, the box-shaped insulating part 31 comprise two recesses, preferably semicircle shaped, one upper recess 32 for the overhead line 33 and one lower recess 34 for the electrical power contact arm 35 of the train 60.

The radius of the two semi-circle shaped recesses 32, 34 are selected to provide an air-gap and a safety distance, between the insulating part 31 and the airline contact lead and the electrical contact arm of the train. The safety distance is, preferably at least 160 mm.

The box-shaped insulating part 31 is further, made of a transparent plastic material, preferably a poly-carbonate material of Lexan type.

Preferably a first motor or compressor driven air fan, not shown, adapted to provide air under pressure, is mounted within an apparatus housing inside of the service building, for flow of air under pressure through a number of air filling ducts, communicating with the interior of the inflatable portions of the right side member 10 of the door seal 1.

Preferably a second air fan, not shown, is mounted in the same apparatus housing, for flow of air under pressure for venting or emptying inflatable portions of the right side door seal via at least one venting duct of the door seal 1, not shown.

Preferably, the main vertical portion 20 is filled with air, preferably via three main filling ducts 21, arranged on the upper right part of the main vertical portion 20, whereby the main filling ducts 21 are connected to the first air compressor via connecting hoses, not shown.

Preferably, the curtain portion 30 is filled with air, via a curtain filling duct 36 arranged on the upper right part of the curtain portion 30, connected to the first air compressor via a connecting hose, not shown.

Preferably, the bottom seal portion 40 is filled with air, via at least one internal duct 42 or valve, arranged between the bottom seal portion and the main vertical portion 20, in the lower left part of the bottom seal portion 40.

Preferably, the bottom seal portion 40 is triangular or sun-fan shaped, comprising at least five parallel elongated tube-shaped air communicating sections 41 extending from the left side of the main vertical portion, preferably obliquely, downwards to the bottom of the seal device 1. The five sections 41 are air communicating with each other via internal ducts 42, shaped such that the bottom seal portion 40 is inflated gradually from right to left. Each tube-shaped inflatable section 41 has a width in the range of 0-30 cm and a length in the range of 50-100 cm.

Preferably, the second air fan is provided for emptying or venting the right-side inflatable member 10 via the at least one venting duct of the seal device 1.

Preferably, the two air fan are connected and disconnected via a central control unit and via control valves, weather the two inflatable members 10, 10′ should be inflated or vented.

Preferably, the retraction system, FIGS. 3 and 4, includes counter-weights, rubber lines, cords and pulleys for retraction of the inflatable members 10, 10′. The retraction system comprise a first retracting part, FIG. 3, for retracting the curtain portion 30 and a second retracting part, FIG. 4, for retracting the vertical main portion 20 and the bottom seal portion 40.

According to one embodiment, the first retraction part of the curtain portion 30, FIG. 3 comprises four vertical elastic rubber lines 37 equally distanced along the curtain portion 30.

At one end, the rubber lines 37 are firmly attached to the lower part of the inflatable curtain portion 30. Preferably, at the other end, the rubber lines 37 are attached and secured to the upper part of the main inflatable portion 20 via a pulley 38 and via a guide loop 39.

Preferably, the second retraction part for the main vertical inflatable portion 20 and the bottom seal portion 40, FIG. 4, comprises two horizontal upper cords 22 extended along the upper part of the main inflatable portion 20, firmly attached, at one end, to the insulating part 31 of the upper left part of the main portion 20, and at the other end, to the upper right side of the main portion 20, via two upper pulleys 23, a first block 24 and a first counterweight 25. Preferably, the lower part of the main inflatable portion 20 comprises four horizontal lower cords 26 firmly attached, at one end, to the left lower side of the main inflatable portion 20 and, at the opposite end, secured to the leg wall via a second counterweight, not shown and via four lower pulleys 27.

Preferably, in order to improve resistance for high forces acting on the fabrics during inflation and retraction of the inflatable portions, the upper and the lower parts of the main inflatable portion 20, are reinforced with metal plates or bars fixed and fastened to the inside of the fabrics, not shown, to which the cords 22 26 are attached.

Preferably, in order to prevent accumulation of condensed water inside the inflatable members (10, 10′), drain openings 70 are arranged in the bottom parts of the inflatable members (10, 10′).

During periods when no loading or unloading is taking place through door opening, the door opening is closed by a conventional door, not shown. In this condition the seal device 1 is in a non-inflated, retracted condition.

Preferably, when a train 60 is positioned in the door opening, the side members 10 and 10′ are inflated by continuous flow of air from the first air fan through the air ducts to the interior of the inflatable portions of the side members 10,10′. Preferably, a constant flow of air into the interior of the seal device 1 in this way, under slight pressure, is sufficient to overcome the retracting forces of the retracting system.

In a similar manner the air pressure in inflating members 10 during inflation overcomes the elastic retracting force of the first retraction part as well as the weight retracting force of the second part retracting part.

The air vent permits fast exit of air under pressure from the system whereby a constant flow of air under pressure is introduced by the second air fan.

What is claimed is:

1. A method of inflating an inflatable door seal, for positioning in an door opening of a wall and for sealing a vehicle, wherein the door seal comprises inflatable members at right and left sides thereof, wherein each of the inflatable members comprises
a vertical inflatable portion comprising an isolating part arranged at an uppermost end thereof,
a curtain portion, and
a bottom seal portion,
the method comprising:
inflating, the inflatable members so that the vertical inflatable portions thereof and the bottom seal portions thereof expand toward a side of the vehicle such that the isolating parts of the inflatable members meet at the vehicle roof; and
inflating the inflatable members so that the curtain portions thereof expand downwards towards the roof of the vehicle.

2. An inflatable door seal for positioning in an door opening of a wall and for sealing a vehicle, wherein the door seal comprises inflatable members at right and left sides thereof, each of the inflatable members comprising at least one vertical inflatable portion for sealing against sides of the vehicle, a curtain portion for sealing against the roof of the vehicle, and a bottom seal portion for sealing between the ground and the vehicle.

3. The inflatable seal according to claim 2, wherein the at least one vertical inflatable portion comprises an isolating, part arranged at it uppermost end for sealing a vehicle with an overhead line and an electrical contact arm of the vehicle.

4. The inflatable seal according to claim 3, wherein the isolating part is box-shaped.

5. The inflatable seal according to claim 3, wherein the isolating part comprises, one upper recess for preventing contact between the inflatable members and the overhead line and one lower recess for preventing contact between the inflatable members and the electrical contact arm of the vehicle when the inflatable seal is inflated.

6. The inflatable seal according to claim 5, Wherein the recesses are semi-circle shaped.

7. The inflatable seal according to claim 2, wherein the at least one vertical inflatable portion is arranged with counterweights to facilitate opening of the seal in inflated and closed state.

8. The inflatable seal according to claim 2, wherein the bottom seal portion comprises at least five parallel elongated tube-shaped air-communicating inflatable sections extending from the right side of the vertical portion, downwards to the bottom of the door seal.

9. The inflatable seal according to claim 7, wherein each of the tube-shaped inflatable section has a width in the range of 0-30 cm and a length in the range of 50-200 cm.
